(19) United States
(12) Patent Application Publication
(10) Pub. No.: US 2025/0081239 A1
(43) Pub. Date: Mar. 6, 2025

(54) PREEMPTION TECHNIQUES FOR TRANSMITTING HIGH PRIORITY PACKETS

(71) Applicant: Apple Inc., Cupertino, CA (US)

(72) Inventors: Morteza Mehrnoush, Hayward, CA (US); Anuj Batra, Redwood City, CA (US); Chittabrata Ghosh, Fremont, CA (US); Mohamed Abouelseoud, Burlingame, CA (US); Oren Shani, Saratoga, CA (US); Wook Bong Lee, San Jose, CA (US); Zhou Lan, San Jose, CA (US)

(21) Appl. No.: 18/819,013

(22) Filed: Aug. 29, 2024

Related U.S. Application Data
(60) Provisional application No. 63/536,042, filed on Aug. 31, 2023.

(51) Int. Cl. H04W 74/0816; H04W 74/08; H04W 74/0838; H04W 80/02

(52) U.S. Cl. CPC H04W 74/0816; H04W 74/0838; H04W 74/0875; H04W 80/02

(57) ABSTRACT

A method for transmitting a high priority (HP) packet from a first wireless device to a second wireless device is described. The method includes determining the presence of an HP packet for uplink transmission; determining that a communications link that uses a wireless medium for transmitting the HP packet is busy; generating a preemption request message in a frame; and transmitting the frame with the preemption request message to the second wireless device. The first wireless device can receive from the second wireless device an indication that the preemption request was accepted, such as by receiving a trigger frame with resource allocation for transmitting the HP packet or an indication of the end of a contention free period, to allow the first wireless device to contend for channel access to transmit the HP packet.

### CROSS-REFERENCE TO RELATED APPLICATIONS

This application claims the benefit of U.S. Provisional Patent Application No. 63/536,042, filed Aug. 31, 2023, the entirety of which is incorporated herein by reference.

### BACKGROUND

Many wireless devices communicate with each other using wireless local area networks (WLANs), such as those based on a communication protocol that is compatible with an Institute of Electrical and Electronics Engineers (IEEE) standard, e.g., the IEEE 802.11 standard (also known as “Wi-Fi”). A WLAN typically includes an access point (AP) that provides one or more stations (STAs) with access to another network, such as the Internet. There are many generations of the IEEE 802.11 standard, including 802.11ax (Wi-Fi 6) and 802.11be (Wi-Fi 7).

IEEE 802.11 is a packet-based protocol. Under this protocol, a transmitter, e.g., an AP, packages control information or user data into a protocol data unit (PDU) in a physical layer convergence protocol (PLCP). The PLCP PDU (PPDU) includes a preamble and a data field, among other fields. After generating the PPDU, the AP can send the PPDU to a STA connected to the AP. Communication from the AP to a STA is referred to as the downlink (DL), and the communication from a STA to the AP is referred to as the uplink (UL).

A PPDU includes a medium access control (MAC) PDU (MPDU), along with the PLCP preamble and PLCP header. The MPDU includes at least one MAC service data unit (MSDU) for transmission, as well as other control information.

### SUMMARY

Some implementations are directed to a method performed by a first wireless device for transmitting a high priority (HP) packet, the method comprising identifying an HP packet for uplink transmission; determining that a communications link for transmitting the HP packet is busy; generating a preemption request message; associating the preemption request message with a frame; and transmitting the frame to a second wireless device.

In some implementations, associating the preemption request message with the frame comprises encoding the preemption request message in an A-Control subfield of a QoS-Null frame, a QoS Data frame, or a management frame.

In some implementations, the QoS-Null frame, the QoS Data frame, or the management frame is encoded in a MAC protocol data unit (MPDU).

In some implementations, generating a preemption request message comprises encoding the preemption request message in the preamble of a PPDU comprising a Control Response frame.

In some implementations, the communications link is busy due to the second wireless device performing a frame burst; and the method further comprising: receiving, from the second wireless device, a trigger frame comprising a resource allocation for sending the HP packet; and sending the HP packet to the second wireless in accordance with the resource allocation indicated by the trigger frame.

In some implementations, the communications link is busy due to the second wireless device being engaged in an on-going transmission opportunity (TXOP).

Some implementations include receiving, from the second wireless device, a contention free (CF) end message; contending for channel access; and transmitting the HP packet using resources allocated after contending for channel access.

Some implementations include receiving an MU PPDU; identifying an element of HP data to send; encoding a preemption request message in a multi-STA BA; and sending the multi-STA BA to the second wireless device.

Some implementations include receiving a trigger frame for sending the HP data; and sending the HP data using a resource associated with the trigger frame.

Some implementations include receiving an RDG message; and sending the HP data in accordance with an RDG parameter associated with the RDG message.

Some implementations include receiving an indication of a contention free end period; contending for channel access to a channel; and transmitting the HP data on the channel.

In some implementations, the communications link is busy due to the second wireless device transmitting one or more physical protocol data units (PPDU).

Some implementations include receiving an MU PPDU that comprises a preemption request message; and encoding a new end of PPDU indication in an MPDU associated with an MU PPDU or an SU PPDU.

Some implementations include receiving a second element of HP data from the second wireless device.

Some implementations include receiving a multi-STA BA during a SIFS period prior to receiving the second element of HP data.

In some implementations, determining that the communications link for transmitting the HP packet is busy comprises determining that a first link of a multi-link connection is busy.

In some implementations, transmitting the frame to the second wireless device comprises transmitting the frame on a second link of the multi-link connection, wherein the preemption request identifies the first link for transmitting the HP packet.

In some implementations, transmitting the frame comprises transmitting the frame on the first link of the multi-link connections, the preemption request identifying the first link for transmitting the HP packet.

Aspects of the implementations are directed to a method performed by a first wireless device in communication with a second wireless device over a wireless link, the method comprising sending one or more lower priority PPDUs to the second wireless device; receiving, from the second wireless device, a request for preemption of a current communication, wherein the request for preemption is received in a QoS-Null frame associated with a Control Response frame, a QoS Data frame, or a management frame; determining to preempt the current communication; sending at least one of a preemption indication or an end of PPDU indication to the second wireless device; and receiving a high priority packet from the second wireless device on the wireless link.

In some implementations, the preemption indication comprises an early block acknowledgement (BA) for a low priority MPDU, a trigger frame, a contention free end frame, or an RDG indication, allowing the second wireless device to use the wireless medium for sending the high priority packet.

In some implementations, the request for preemption is encoded in an A-Control subfield of a Control Response frame, a QoS Data frame, or a management frame.

In some implementations, the request for preemption comprises information corresponding to the high priority packet, including an indication of an amount of data associated with the high priority packet.

Some implementations include encoding a new end of PPDU indication in a last MPDU of a low priority PPDU; transmitting the last MPDU in the last low priority PPDU to the second wireless device; and receiving an early BA.

Some implementations include encoding a TXOP take over (TOT) indicator with the new end of PPDU indication to alert the second wireless device that the first wireless device will take over the TXOP.

In some implementations, the new end of PPDU indication is encoded in an A-Control subfield of a last MPDU associated with a TXOP.

Some implementations include sending a multi-user (MU) PPDU addressed to multiple second wireless devices; receiving, from at least one of the multiple second wireless devices, a multi-STA BA comprising the preemption request message; sending a contention free end indication or a trigger frame or using a reverse direction grant (RDG) mechanism to at least one of the multiple second wireless devices, wherein the RDG mechanism can grant the remaining TXOP to the second wireless device; and receiving, from at least one of the second multiple devices, the HP transmission.

Some implementations include encoding, in one or more MPDUs contained in a multi-user (MU) PPDU (MU PPDU), a preemption request message; sending the MU PPDU addressed to multiple second wireless devices; receiving, from at least one of the multiple second wireless devices, a new end of PPDU indication; transmitting an MU block acknowledgement to the at least one of the multiple second wireless devices; and transmitting the HP PPDU(s) to the at least one of the multiple second wireless devices.

In some implementations, the first wireless device sends a preemption request indication to multiple second wireless devices operating in a multi-user network environment using a first link.

In some implementations, at least one of the multiple second wireless devices comprises a wireless station in a multi-link device (MLD).

Some implementations include receiving from at least one of the multiple second wireless devices, a PPDU early termination indication that indicates that at least one second wireless device has accepted the preemption indication request.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE DRAWINGS

FIG. 1 illustrates a block diagram of example of wireless devices communicating wirelessly, according to some implementations.

FIG. 2 is an example schematic diagram of an overview of preempting a TXOP using an A-Control subfield of a QoS Null (QN) frame in accordance with some implementations of the present disclosure.

FIG. 3 is an example schematic diagram of an overview of preempting a TXOP using a preamble of a PPDU that carries an A-control response frame in accordance with some implementations of the present disclosure.

FIG. 4 is a schematic diagram of an example single link system 400 illustrating a preemption of a frame burst in accordance with some implementations of the present disclosure.

FIG. 5 is a schematic diagram of an example single link system 500 illustrating a preemption of a TXOP in accordance with some implementations of the present disclosure.

FIG. 6 is a schematic diagram of an example multi-link system illustrating a preemption of a frame burst on one link of a multi-link operation (MLO) using simultaneous transmit and receive (STR) in accordance with some implementations of the present disclosure.

FIG. 7 is a schematic diagram of another example multi-link system 700 illustrating a preemption of a frame burst on one link of a multi-link operation (MLO) using simultaneous transmit and receive (STR) in accordance with some implementations of the present disclosure.

FIG. 8 is a schematic diagram of an example Enhanced Multi-Link Single Radio (EMLSR) system where a STA can request TXOP/frame burst preemption using a preemption request message encoded in an A-Control subfield in accordance with some implementations of the present disclosure.

FIG. 9 is a schematic diagram of another example Enhanced Multi-Link Single Radio (EMLSR) system where a STA can request TXOP/frame burst preemption using a preemption request message encoded in an A-Control subfield in accordance with some implementations of the present disclosure.

FIG. 10 is a schematic diagram of an example MLO system that includes a PPDU preemption in accordance with some implementations of the present disclosure.

FIG. 11 is a schematic diagram of a second example MLO system that includes a PPDU preemption in accordance with some implementations of the present disclosure.

FIG. 12 is a schematic diagram illustrating an example single-link system 1200 where a STA preempts its own PPDU in accordance with some implementations of the present disclosure.

FIG. 13 is a schematic diagram illustrating an example enhanced multi-link single radio (EMLSR) system 1300 where a STA preempts its own PPDU in accordance with some implementations of the present disclosure.

FIG. 14 illustrates a block diagram of an example wireless device, according to some implementations.

Like reference numbers indicate like features of components.

### DETAILED DESCRIPTION

A station (STA), including an access point (AP) station (AP STA) or non-AP STA, may have one or more high priority (HP) packets available for transmission. The link for transmitting the HP packet(s), however, may be busy due to uplink (UL) or downlink (DL) activity.

For example, a single link STA, including an AP or non-AP STA, or a multi-link device (MLD), including an AP MLD or non-AP MLD, may have HP packets to transmit. The single links or multiple links may be busy due to UL or DL transmission opportunities (TXOP) or frame-bursts. The STA may have to wait until the end of the TXOP or completion of the frame burst before sending the HP packets, and even then, the STA may have to contend for resources with other STAs for sending the HP packets, so access to the channel is not guaranteed. Contention for resources can contribute to additional delays in sending the HP packets.

This disclosure describes techniques for TXOP/frame-burst preemption so that HP packets can be sent with minimal delay. Depending on the length of the number of frame sequences in the frame-bursting/TXOP, and each PPDU duration within the burst, preempting the frame bursting or TXOP that carries low priority (LP) traffic can help to improve the HP traffic latency.

An MLD may request the preemption of a TXOP/frame-burst over the same or another link for the following reasons: if an ongoing transmission over a link contains HP packets, the MLD may request to preempt the TXOP on the other link, which carries low priority data; the MLD may prefer to use the other link with higher BW and link quality, e.g., simultaneous transmission and receive (STR) case with two links on 2.4 GHz and 5 GHz band. The MLD may prefer to use the link with higher BW, which may be busy due to an on-going low priority TXOP or frame burst; due to traffic identifier (TID)-to-link mapping negotiation, the HP packets may have to be delivered over a link that is undergoing TXOP/frame burst.

This disclosure describes mechanisms for a STA or MLD to preempt on-going transmissions using a preemption request signal. In some implementations, if a STA or MLD has HP packets, the STA or MLD can indicate the TXOP/frame-burst preemption request to the other STA or MLD in UL or DL over the same link or cross link. That is, a first STA can send a request for TXOP/frame burst preemption on a link to a second STA or MLD. In a multi-link operation (MLO) scenario, the request for TXOP/frame burst can be a request for channel access to the same first link or to a different, second link (so-called cross link). The term “same link” implies that the preemption indication is transmitted on the same link the MLD is requesting for preemption; while “cross link” implies that the preemption indication is transmitted on a different link than the MLD is requesting for preemption. The second STA or MLD can use the information in the preemption request to decide whether to preempt an ongoing TXOP/frame-burst.

In the MLO scenario, when a first MLD (AP MLD or non-AP MLD) has high priority (HP) packets but all the links are busy due to UL and/or DL PPDUs (e.g., carrying low priority (LP) traffic), the first MLD with HP packets has to wait until the end of the PPDU to transmit the HP packets. In the MLO scenario, a first MLD can transmit a preemption request in an A-Control subfield to a second MLD using the same link or a cross link. An MLD with HP packets can use the A-Control subfield to signal the preemption indication to the other MLD using a Control-ID and a SubType in the A-Control subfield. The Link-ID subfield can be used to indicate which link is being requested for preemption (i.e., the same-link or a cross-link).

In some implementations, an A-Control subfield can be used to transmit a preemption request from a first STA or MLD to a second STA or MLD. The A-Control subfield in the QoS Data, QoS Null, and management frames can be used. The receiver of the preemption indication uses this information to decide whether to perform the preemption. The A-Control subfield is part of the high-throughput (HT) Control field. The HT Control field is always present in a Control Wrapper frame and is present in QoS Data, (11ax) QoS Null, and Management frames as determined by the +HTC subfield of the Frame Control field as defined in § 9.2.4.1.10 (+HTC subfield). The A-Control can be encoded in an MPDU. QoS-Null and block acknowledgement (BA) can be aggregated and sent as a Control response frame (in a PPDU).

For example, a preemption request can cause the second STA or MLD to cease use of the desired link to allow the first STA or MLD access to the channel for transmitting the HP packets. In some implementations, the second STA or MLD can send a new end of PPDU indication in response to the preemption indication. The A-Control subfield can be implemented as or resemble a format shown in Table 1.

TABLE 1
A-Control Subfield Format.

| Control ID | SubType | Link ID | Reserved |
|---|---|---|---|
| 4 bits | 4 bits | 16 bits | 6 bits |

The A-Control subfield includes a Control ID and a SubType. The SubType can indicate the purpose of the Link ID bitmap. The Control ID can be defined to indicate that the A-Control is for preemption. The Link ID shows the link index for which the indication applies.

In some implementations, the preemption request can be transmitted in the preamble of the PPDU, which carries the Control Response (CR) frame. In some implementations, the second STA or MLD can grant the first STA or MLD channel access, as described in more detail below.

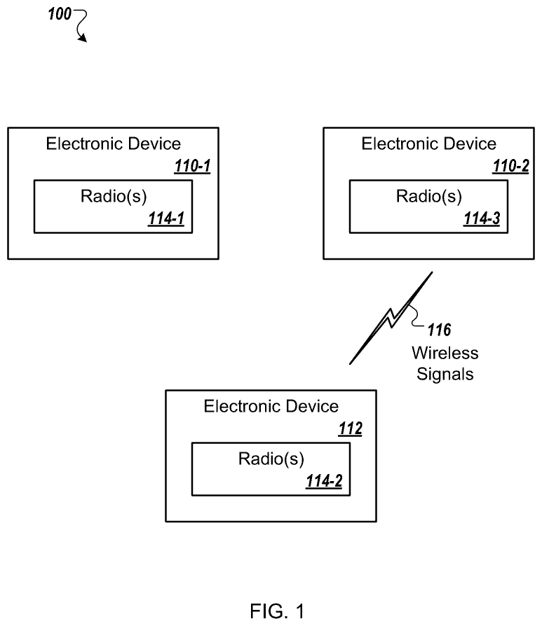

FIG. 1 illustrates a block diagram of an example system 100 that includes a set of wireless devices communicating with each other using a wireless medium, according to some implementations. The system 100 can include a first wireless device 110-1 wirelessly associated with a second wireless device 112. The wireless device 110-1 can communicate with the second wireless device 112 using wireless signals 116. The system 100 can also include a third wireless device 110-2 also wirelessly associated with a second wireless device 112. In some implementations, the first wireless device 110-1, the second wireless device 112, and the third wireless device 110-2 include wireless stations (STA).

The first wireless device 110-1 includes one or more communication radios 114-1. The first wireless device 110-1 can be a single link device or a multi-link device (MLD). In some embodiments, the first wireless device 110-1 is referred to as a STA, MLD, or non-AP STA or non-AP MLD. An MLD can be characterized as having multiple STAs or radios, each STA or radio being able to communicate on its own communications link. The third wireless device 110-2 includes one or more communication radios 114-3. The first wireless device 110-2 can be a single link device or a multi-link device (MLD). In some embodiments, the first wireless device 110-2 is referred to as a STA, MLD, or non-AP STA or non-AP MLD. In some examples described herein, the first wireless device 110-1 and the third wireless device 110-2 can be wireless devices, (e.g., a smartphone, a laptop computer, a notebook computer, a tablet, set top box, gaming console, smart watch, or another such wireless device). Generally, in connection with FIG. 1, wireless devices 110-1 and 110-2 are referred to as wireless device(s) or STA 110.

Second wireless device 112 can also include one or more radios 114-2. The second wireless device 112 can be a single link device or an MLD. In some embodiments, the second wireless device 112 is referred to as an AP, an AP STA, or AP MLD. An MLD, for example, may have multiple AP STAs or radios, each capable of communicating with other STAs or MLDs across a communication link. Generally in connection with FIG. 1, second wireless device 112 can be referred to as AP 112.

A STA 110 and AP 112 can communicate wirelessly in a WLAN using an IEEE 802.11 communication protocol. Thus, wireless devices 110 can be associated with or can have a connection with AP 112. For example, wireless devices 110 and AP 112 can wirelessly communicate while: detecting one another by scanning wireless channels, transmitting and receiving beacons or beacon frames on wireless channels, establishing connections (e.g., by transmitting connect requests), and/or transmitting and receiving packets or frames (which can include the request and/or additional information, such as data, as payloads). Note that the AP 112 can provide access to a network, such as the Internet, via an Ethernet protocol, and can be a physical access point or a virtual or “software” access point that is implemented on a computer or an wireless device. In this specification, wireless devices 110 are sometimes referred to as “recipient wireless devices” or “receiver stations.”

Although the environment shown in FIG. 1 is provided as an example, in alternative implementations, different numbers and/or types of wireless devices can be present. For example, some implementations can include more or fewer wireless devices. As another example, in some implementations, different wireless devices can be transmitting and/or receiving packets or frames. In some implementations, multiple links can be used during communication between wireless devices 110.

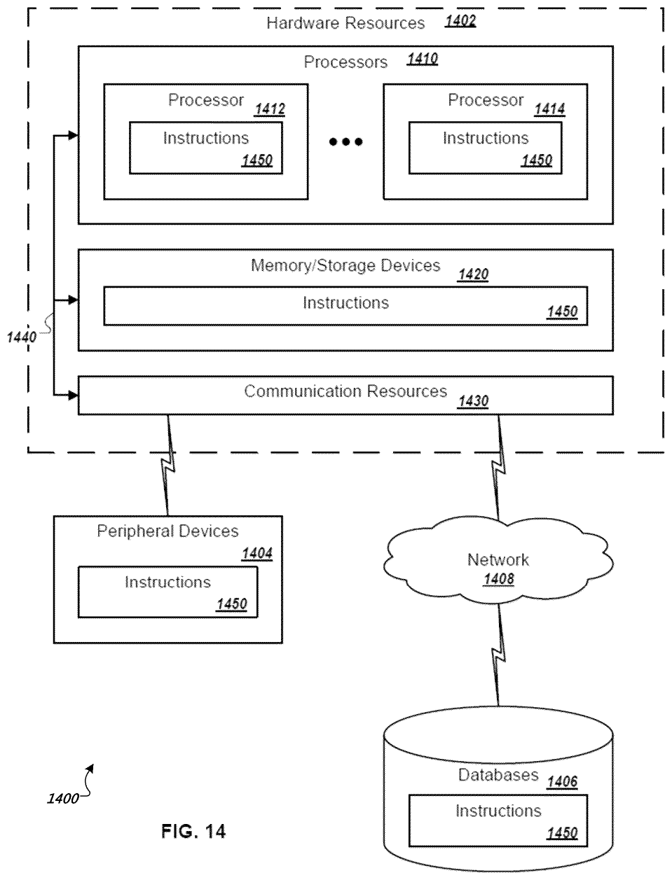

As described further below with reference to FIG. 14, wireless devices 110 and AP 112 can include subsystems, such as a networking subsystem, a memory subsystem, and a processor subsystem. In addition, wireless devices 110 and AP 112 can include radios 114 in the networking subsystems. More generally, wireless devices 110 and AP 112 can include (or can be included within) any wireless devices with networking subsystems that enable wireless devices 110 and AP 112, respectively, to wirelessly communicate with another wireless device. This can include transmitting beacons on wireless channels to enable the wireless devices to make initial contact with or to detect each other, followed by exchanging subsequent data/management frames (such as connect requests) to establish a connection, configure security options, transmit and receive packets or frames via the connection, etc.

As shown in FIG. 1, wireless signals 116 are communicated by one or more radios 114-1 and 114-2 in wireless device 110-1 and AP 112, respectively. For example, as noted previously, wireless device 110-1 and AP 112 can exchange packets or frames using a Wi-Fi communication protocol in a WLAN. Further, one or more radios 114-1 can receive wireless signals 116 that are transmitted by one or more radios 114-2 via one or more links between wireless device 110-1 and AP 112. Alternatively, the one or more radios 114-1 can transmit wireless signals 116 that are received by the one or more radios 114-2.

In some implementations, wireless signals 116 are communicated by one or more radios 114 in wireless devices 110 and AP 112, respectively. For example, one or more radios 114-1 and 114-3 can receive wireless signals 116 that are transmitted by one or more radios 114-2 via one or more links between the wireless devices 110-1 and 110-2, and the AP 112.

In some implementations, the AP 112 can group the wireless devices 110 into a target station set. The target station set concept comes from downlink multi-user transmission where the AP 112 can transmit to multiple stations simultaneously in one PPDU using Orthogonal Frequency Division Multiple Access (OFDMA) or multiuser (MU) Multiple Input Multiple Output (MU-MIMO). Here, the target station set is a set of stations that can simultaneously be served by the AP 112. The stations in the set do not need to share the same PHY parameters, such as MCS, number of streams, etc.

In some implementations, the AP 112 can simultaneously communicate with a plurality of wireless devices 110 using multiuser (MU) techniques, such as MU Multiple Input Multiple Output (MU-MIMO). In some examples, the AP 112 communicates with the wireless devices 110 using frequency multiplexing such that the AP 112 allocates each of the wireless devices a portion of the overall bandwidth. For example, to simultaneously communicate with four wireless devices over an 80 Megahertz (MHz) bandwidth, the AP 112 transmits a MU-PPDU over the 80 MHz bandwidth. The MU-PPDU includes a sub-PPDU for each of the four wireless devices, where each sub-PPDU (or sub-channel) is allocated 20 MHz. The AP 112 can use the MU-PPDU to communicate with devices in the same target set, devices in different target sets, or a combination of both.

In some implementations, AP 112 and one or more wireless devices can be compatible with an IEEE 802.11 standard that includes trigger-based channel access, e.g., IEEE 802.11ax. In 802.11ax, Orthogonal Frequency Division Multiple Access (OFDMA) is used to enable simultaneous communications between the AP 112 and multiple wireless devices. OFDMA divides the available physical spectrum into multiple orthogonal sub-channels, or resource units (RUs), which can be allocated to different wireless devices (users). Under the standard, the AP 112 coordinates multiuser OFDMA by broadcasting a trigger frame which, among other things, allocates a RU to each participating wireless device. Each wireless device responds to the trigger frame by transmitting a PPDU to the AP 112 using the allocated RU. The trigger frame can also include power control information. The AP 112 can instruct all wireless devices 110 when to start and stop transmitting. Note that AP 112 and the wireless devices 110 can communicate with one or more legacy wireless devices that are not compatible with the IEEE 802.11 standard (i.e., that do not use multi-user trigger-based channel access).

In some implementations, processing a packet or frame in one of wireless devices 110 AP 112, or a combination of both, includes: receiving wireless signals 116 encoding a packet or a frame; decoding/extracting the packet or frame from received wireless signals 116 to acquire the packet or frame; and processing the packet or frame to determine information contained in the packet or frame (such as data in the payload).

As discussed previously, one or more of wireless devices 110 and AP 112 can communicate with each other. Notably, AP 112 can transmit a PPDU that includes a preamble and a data field. In some implementations, AP 112 can be configured to use concatenated PPDUs (C-PPDUs), e.g., for low latency communications with receiver stations. A C-PPDU includes a plurality of component PPDUs, each of which includes preamble and a data payload. As described in more detail below, the C PPDU includes a plurality of component PPDUs. The first component PPDU is preceded by a first preamble called a “full preamble.” The remaining component PPDUs in the C-PPDU are each preceded by respective preambles that are shorter in length than the first preamble. In some implementations, the AP 112 might not perform contention or receive a block acknowledgement (BA) before the plurality of component PPDUs are transmitted. A PPDU can include a plurality of MPDUs and a PPDU preamble and header information.

When a STA (AP or non-AP STA) or MLD (AP MLD or non-AP MLD) has high priority (HP) packets and the link(s) are busy due to uplink (UL) or downlink (DL) TXOP or frame-burst, the STA with the HP packets has to wait until the end of the TXOP or ongoing frame-burst. (There maybe multiple TXOPs in a frame burst sequence.) After the end of the ongoing TXOP or frame burst, the STA contends to deliver the HP traffic where the access to the channel is not guaranteed and may cause extra delay.

Depending on the length of the number of frame sequences in the frame-bursting/TXOP, and each PPDU duration within the burst, preempting the frame bursting or TXOP that carries low priority (LP) traffic can help to improve the HP traffic latency. In the MLO case, an MLD device may request the preemption of a frame-burst/TXOP for the following reasons:

If a first STA or MLD (AP or non-AP) has HP packets, the STA can indicate a TXOP/frame-burst preemption request to the second STA or MLD (non-AP or AP) in UL or DL over the same link or cross link. The second STA or MLD uses this preemption information to decide about preempting its ongoing TXOP/frame-burst or not.

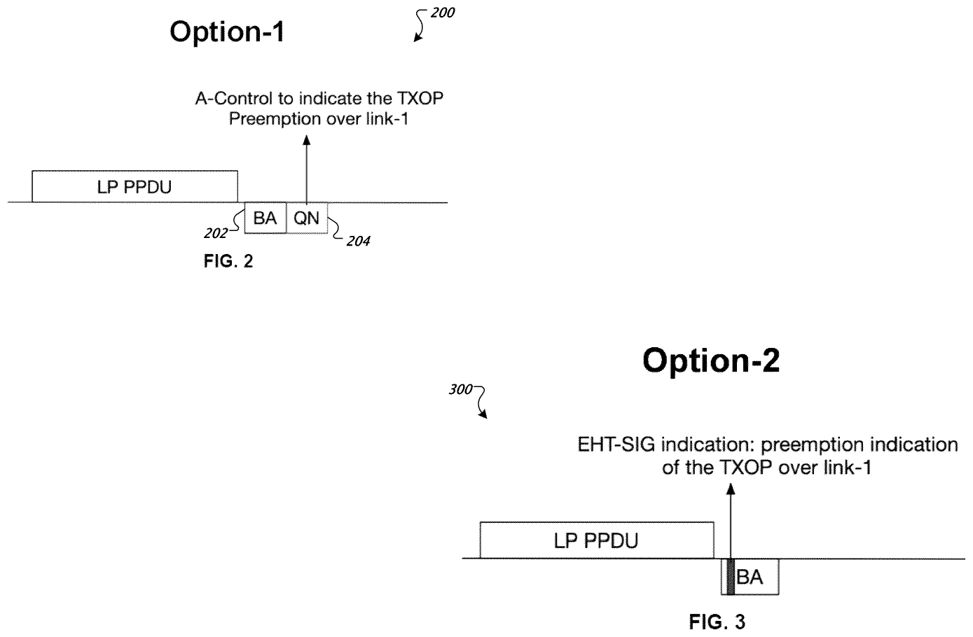

There are two options for frame-bursting/TXOP preemption indication. Option-1 (MAC indication) is illustrated by FIG. 2, which is a schematic diagram of an overview of preempting a TXOP using an A-Control subfield of a QoS Null (QN) frame 204 in accordance with some implementations of the present disclosure. The STA or MLD can deliver the preemption indication in the A-Control subfield of an MPDU in the Control Response (CR) frame. For example, a block acknowledgement (BA) 202 can be transmitted by the first STA or MLD with a QoS Null frame 204 encoded with A-Control subfield for the preemption request. Option 1 can do the frame-bursting/TXOP preemption indication up to 16 links.

Option-2 (PHY preamble indication) is illustrated by FIG. 3, which is a schematic diagram 300 of an overview of preempting a TXOP using a preamble of a control response frame in accordance with some implementations of the present disclosure. The STA or MLD can deliver the preemption indication in the preamble of the PPDU which carries the Control Response (CR) frame by using the EHT-SIG field. For example, in EHT MU PPDU preamble, B13-B16 in the Common field of the extremely high throughput (EHT)-SIG frame can be used for preempting the TXOP/frame burst (currently bits B13-B16 are the disregard subfield in 802.11be); for UHR, a new subfield can be defined for the preemption indication. Each bit can represent a preemption request and the bit mapping can indicate the desired link.

Option 2 may have a lower modulation and coding set (MCS) rate index for EHT-SIG, like frame-bursting/TXOP duration indication in PHY. Option 2 can be used alone or in combination with Option 1 (MAC indication).

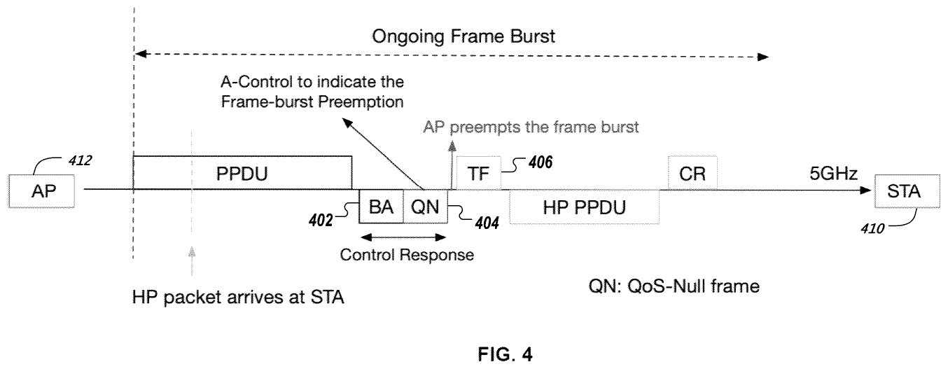

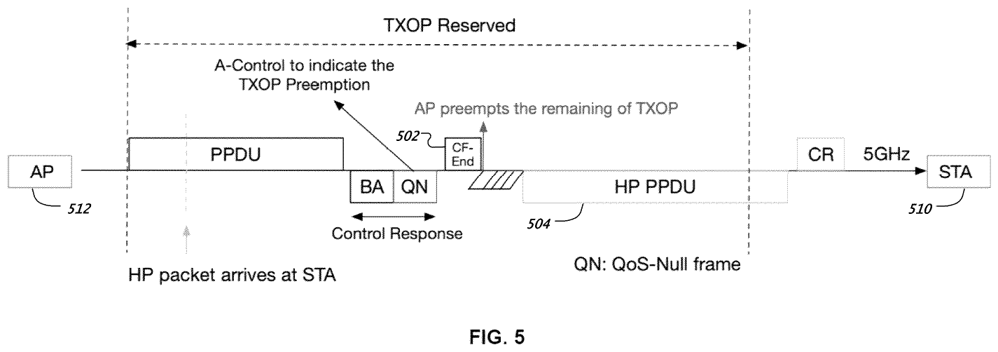

FIG. 4 is a schematic diagram of an example single link system 400 illustrating a preemption of a frame burst in accordance with some implementations of the present disclosure. In FIG. 4, the single link between the STA 410 (or non-AP STA, but here simply STA) and the AP 412 is busy due to an on-going frame burst, and the STA 410 receives an HP packet while a frame burst (or TXOP) is occurring. (For the non-AP STA, the single link scenario can apply when the non-AP STA is operating one of its links.) Here, the frame burst is a downlink frame burst of PPDUs. The STA 410 indicates the frame-burst/TXOP preemption using an A-Control subfield in QoS-Null 404 to AP 412. The STA 410 can send a BA 402 and QN 404 to the AP 412 as a response to receiving the PPDU. The preemption request can include an identification of the data the STA 410 has to deliver like access category for the HP packets, the amount of data, and other information about the payload.

When the AP 412 receives the preemption request, the AP 412 can determine whether to preempt the frame burst/TXOP. If the AP 412 decides to preempt the frame-burst/TXOP, the AP 412 can send a trigger frame (TF) 406 to the STA 410. The TF 406 provides the STA 410 with resource allocation for the HP packet in UL for delivering the HP packets during the remaining TXOP. Note that the preemption indication can be carried in the EHT-SIG as well, i.e. option-2.

In this example, if the TXOP duration is reserved for multiple frame exchanges, another option is that the STA 410 takes over the TXOP on link-1 using the reverse direction grant (RDG) protocol. The AP 412 after receiving the preemption request indication sends a PPDU with RDG=1 to grant the TXOP to STA 410. If the STA 410 delivered all the HP traffic and any TXOP duration is left, the STA 410 can similarly return the TXOP to the AP 412 after transmission. This permits fast access to the medium right after the current frame sequence.

FIG. 5 is a schematic diagram of an example single link system 500 illustrating a preemption of a TXOP in accordance with some implementations of the present disclosure. Similar to FIG. 4 (Case 1), the STA 510 determines that it has HP traffic 504 to send on the UL, but the link is busy. The STA 510 sends the preemption request as before by encoding a QoS Null A-Control field with a preemption request. In this case (Case 2), the TXOP is reserved for multiple frame exchanges. After the AP 512 receives the preemption request and decides to preempt the TXOP, the AP 512 preempts the TXOP by sending a Contention Free-End (CF-END) message 502 to the STA. The CF-End control frame 502 indicates the end of the contention-free period, which means that the STA 510 is able to contend for channel access. After receiving the CF-End message 502, the STA 510 contends to access the channel.

Taking over the frame-burst/TXOP allows full TXOP use. For the frame burst option, the AP 512 does not know the STA's traffic, so the STA 510 can contend for its corresponding access category.

In both Case-1 and 2, the STA 510 can indicate its intention of either being polled in UL, using RDG, or wanting new access to the channel, in the same A-Control field.

If the A-Control subfield or EHT-SIG preemption indication is not received by AP 512, AP 512 continues the frame bursting or TXOP and STA 510 has to wait until the end of the frame bursting or TXOP to transmit the HP packets 504. Preemption allows the STA 510 to at least try to send the HP packets 504 earlier.

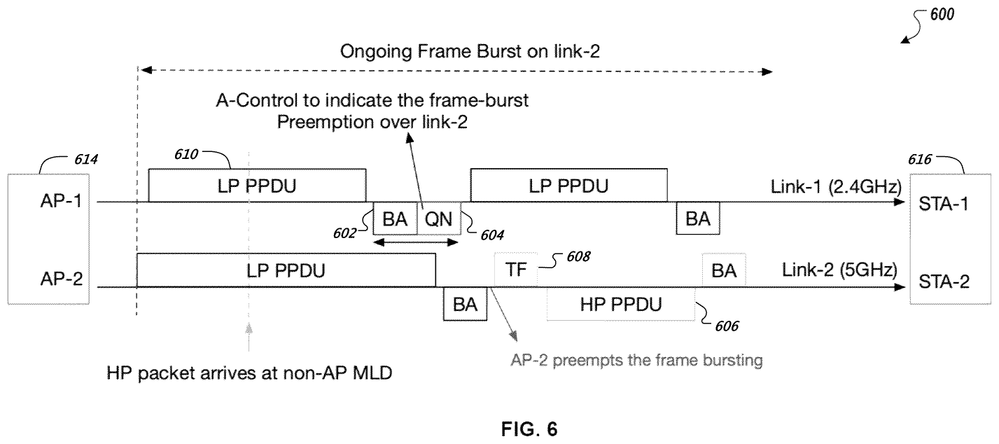

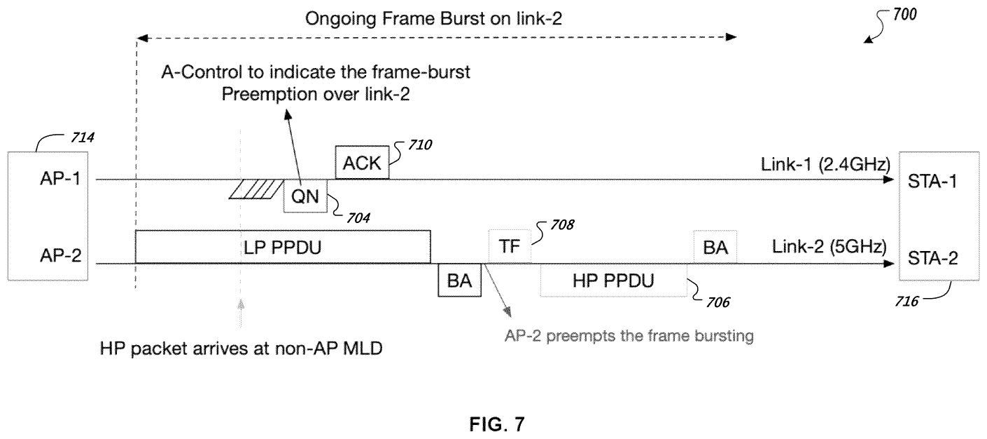

FIGS. 6 and 7 illustrate TXOP/Frame Burst Preemption for Multi-Link Operation-Simultaneous Transmit and Receive (MLO-STR) operations. The examples described below are STR cases with link 1 on 2.4 GHz with BW=20 MHz and link 2 on 5 GHz with BW=80 MHz. The AP MLD 614 can include AP-1 and AP-2; the non-AP MLD 616 can include STA-1 and STA-2. In the examples below, AP-1 can communicate with STA-1 using link 1; and AP-2 can communicate with STA-2 using link 2.

If link-2 is BUSY, the non-AP MLD 616 can send the preemption request in the QN 604 aggregated with the BA 602 (first BA from STA-2). In general, the preemption indication can be sent by accessing the channel to send the QN 604, send it aggregated with BA 602, or in a QoS Data frame.

FIG. 6 is a schematic diagram of an example multi-link system 600 illustrating a preemption of a frame burst on one link of a multi-link operation (MLO) using simultaneous transmit and receive (STR) in accordance with some implementations of the present disclosure. In FIG. 6, a frame burst is occurring on link 2. The non-AP MLD 616 can determine that it has HP packet(s) 606 to send on one link (either link 1 or link 2) of the multi-link connection. STA-1 indicates the preemption to AP-1 over link 1 to preempt the frame-burst over link-2. The preemption indication is transmitted in A-Control subfield in QoS-Null 604.

If the AP MLD 614 decides to preempt the frame burst on link 2, AP-2 preempts the frame-burst in DL, and sends a TF 608 to trigger STA-2 of non-AP MLD 616 in UL for delivering the HP packets 606. If the TXOP was reserved for multiple frame exchanges, the TXOP could be preempted. And similar to the single link case, two other options can be implemented: using the RDG protocol for taking over the TXOP; or AP sending the CF-End to end the TXOP and STA-2 to contend for a full TXOP. After the STA-2 receives the TF, STA-2 can transmit the HP packet(s) 606 over link 2 using the resources in the TF 608.

FIG. 7 is a schematic diagram of another example multi-link system 700 illustrating a preemption of a frame burst on one link of a multi-link operation (MLO) using simultaneous transmit and receive (STR) in accordance with some implementations of the present disclosure. As depicted in FIG. 7, STA-1 wants to use link 2 for delivering the HP traffic. Thus, STA-2 accesses the channel and transmits a QoS-Null (QN) 704 with A-Control encoding for preemption to indicate the frame-burst preemption.

The QN 704 for the frame-burst preemption indication may be sent over the other link. For example, AP-2 can decide to preempt the frame-burst in DL over link-2, and sends a TF 708 to trigger STA-2 of non-AP MLD 716 in UL for delivering the HP packets 706. After STA-2 receives the TF 708, STA-2 can transmit the HP packet(s) 706 over link 2 using the resources in the TF 708.

The difference between Case 1 (FIG. 6) and Case 2 (FIG. 7) is that for FIG. 6, link-1 is busy, so the QN 604 (and preemption indication) is sent as the response to LP PPDU 610. In FIG. 7, the non-AP MLD 716 can access the channel on link 1 to send the QN frame 704 also on link 1; and then the non-AP MLD 716 can receive an ACK 710 from the AP MLD 714 for the QN 704.

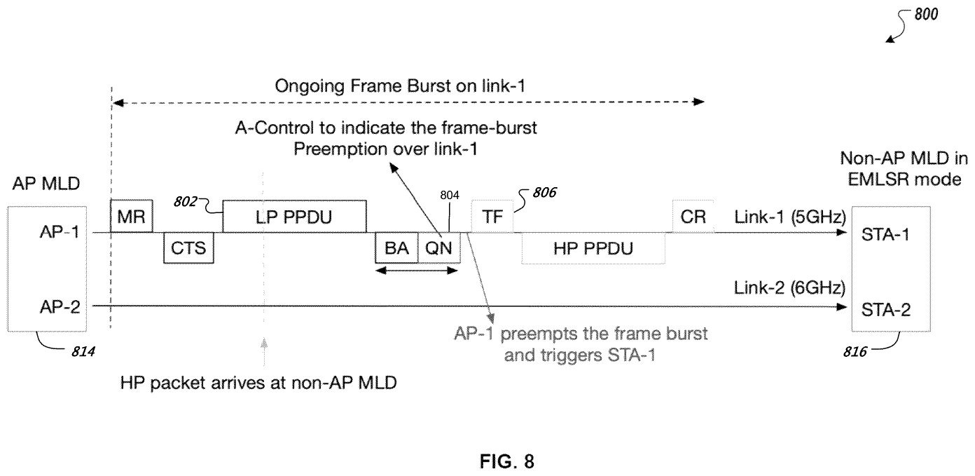

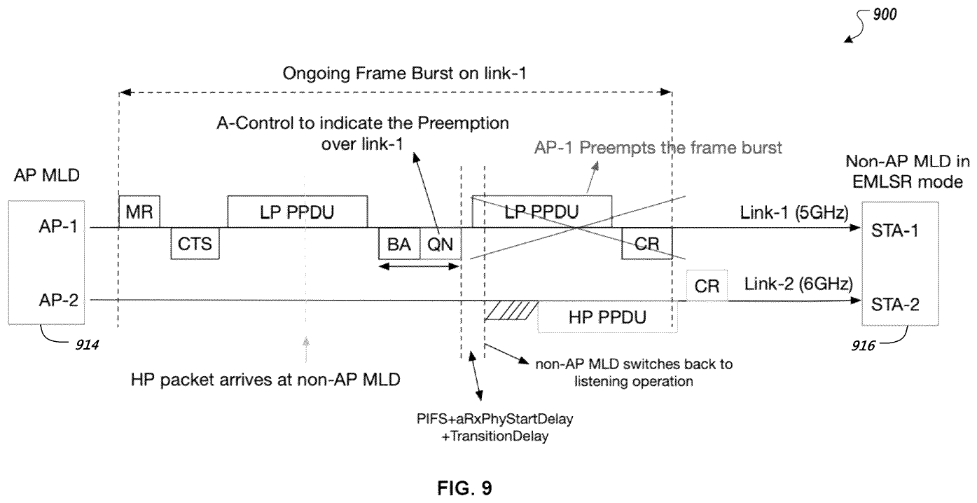

FIGS. 8 and 9 illustrate TXOP/Frame-Burst Preemption for Enhanced Multi-Link Single Radio. A non-AP MLD 816 can implement Enhanced Multi-Link Single Radio (EMLSR) operation when the device has single radio and can operate on multiple links following the EMLSR procedure. Non-AP MLD 816 in EMLSR operation, upon receiving the initial control frame (MU-RTS or BSRP) from the AP MLD 814 over one of the links, switches to that link to receive the rest of the TXOP.

FIG. 8 is a schematic diagram of an example of Enhanced Multi-Link Single Radio (EMLSR) system 800 where a STA of non-AP MLD 816 operating in EMLSR mode can request TXOP/frame burst preemption using a preemption request message encoded in an A-Control subfield in accordance with some implementations of the present disclosure. In FIG. 8 (Case-1), the AP MLD 814 can send traffic (LP PPDU 802) on link 1 from AP-1 to STA-1 (of non-AP MLD 816) as part of an on-going frame burst or TXOP. The non-AP MLD 816 may prefer to send the HP traffic on link 1. STA-1 of non-AP MLD 816 indicates the preemption using A-Control subfield in the QoS-Null 804 to AP-1. AP-1 preempts the frame-burst, and send a TF 806 to trigger STA-1 of non-AP MLD 816 in UL over the same link for delivering the HP packets.

In case-2 (depicted in FIG. 9), STA-1 of non-AP MLD 916 indicates the frame-burst preemption for link-1 and then non-AP MLD 916 can use any of the links to transmit. FIG. 9 is a schematic diagram of another example Enhanced Multi-Link Single Radio (EMLSR) system 900 where a non-AP MLD 916 can request TXOP/frame burst preemption over a link using a preemption request message encoded in an A-Control subfield in accordance with some implementations of the present disclosure. FIG. 9 is similar to FIG. 8 in that an HP packet arrives during a frame burst. After frame-burst preemption indication, AP MLD 914 terminates the frame bursting over link-1. After a time period (as indicated in the FIG. 9) the non-AP MLD 916 switches back to a listening operation after determining the end of frame exchange and contends to start a new TXOP over link-2. In this case, non-AP MLD 916 prefers Link-2 because of higher BW and/or TID-to-link mapping or other reasons. EMLSR end of frame exchange determination follows the rules in 802.11be specification.

In multi-user (MU) scenario, only the non-AP STA can request the AP for the preemption in DL or trigger based UL. Non-trigger based UL preemption, where AP asking the STA to preempt its UL frame exchange, is equivalent to the single-user preemption case that are already discussed in connection with FIGS. 4 and 5. Both Option-1 and Option-2 can be applied to multi-user (MU) cases.

Option-1: In DL-MU frame exchange, a STA can indicate the preemption indication to the AP by indicating its request in the Multi-STA Control Response, i.e. QoS-Null aggregated with the Multi-STA BA as the response. In UL-multi-user (MU) frame exchange (trigger based), a STA can indicate the preemption indication to the AP by indicating its request in the A-Control of the MPDUs in the UL traffic delivery.

Option-2: In DL-MU frame exchange, a STA can indicate the preemption indication to the AP by indicating its request in the preamble, i.e. UHR-SIG, of the Multi-STA BA. In UL-MU frame exchange (trigger based), a STA can indicate the preemption indication to the AP by indicating its request in the preamble, i.e. ultra-high reliability (UHR)-SIG, of UL TB PPDU. If the AP, upon receiving the request, can do preemption, the AP polls (triggers) the STA in UL or early terminate its DL/UL TXOP to let the STA access the channel for HP packet UL traffic delivery.

PPDU Preemption and Early PPDU Termination: a first MLD with HP packets uses the A-Control subfield for the preemption indication to a second MLD. An example of an A-Control subfield is shown in Table 2.

TABLE 2
A-Control Subfield for Requesting PPDU Preemption

| Control ID | SubType | Link ID | Reserved |
|---|---|---|---|
| 4 bits | 4 bits | 16 bits | 6 bits |

The A-Control subfield can include a Control-ID and a SubType in the A-Control subfield. The Link-ID subfield will be used for the same-link or cross-link preemption indication (i.e., the Link-ID is used to identify which link the HP packet is to be transmitted on). The receiver of the preemption indication uses this information and decide to do the preemption or not.

This disclosure describes a new End of PPDU Indication: If the second MLD decides to do the preemption, the second MLD needs to indicate the new end of preempted PPDU, so that the first MLD can prepare the BA SIFS after the end of preempted PPDU. The A-Control signaling can be used by the second MLD to indicate the new end of PPDU. The A-Control subfield can also be used as an indicator to the first MLD to take over the TXOP after the preemption.

The A-Control subfield can be used as the new end of PPDU indication. Table 3 shows an example A-Control subfield for new end of PPDU indication.

TABLE 3
A-Control Subfield for New End of PPDU Indication

| Control ID | SubType | PPDU END | ToT | Reserved |
|---|---|---|---|---|
| 4 bits | 4 bits | 1 bits | 1 bit | 20 bits |

The A-Control subfield Control-ID and a new SubType can be encoded in the last MPDU of the PPDU. If the second MLD does not indicate a new end of PPDU (i.e., the end of the preempted PPDU), the first MLD will not know the actual end of the preempted PPDU. So the first MLD cannot send the HP packet(s) or the block acknowledgement (BA) response, and will continue decoding up to the end of L-SIG length (the L-SIG length indicating the original end of the PPDU transmission by the second MLD).

Control-ID is the same between Tables 2 and 3. But there is a different Subtype for different functions. For example, Subtype=0 can be set for TXOP preemption request, Subtype=1 for PPDU preemption request, and Subtype=2 for the New End of PPDU indication.

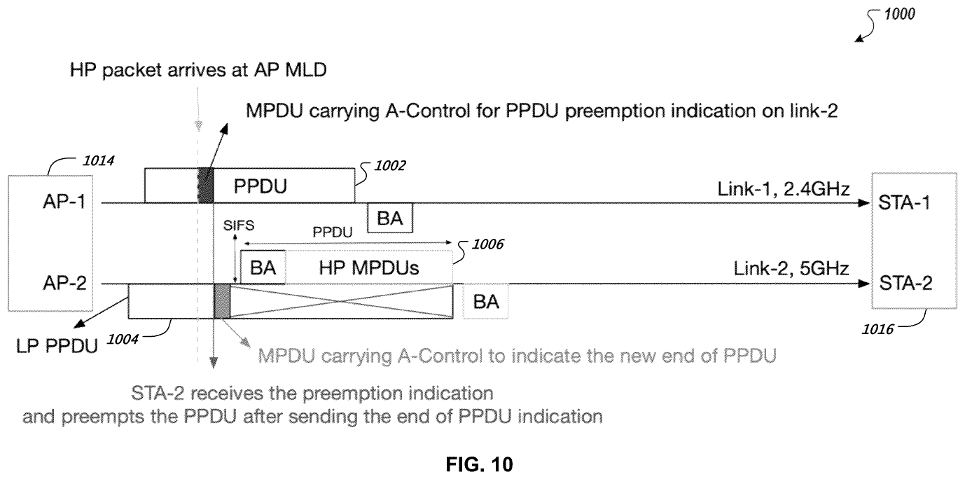

FIG. 10 is a schematic diagram of an example MLO system that includes a PPDU preemption in accordance with some implementations of the present disclosure. FIG. 10 shows a PPDU preemption indication sent in a first link and a new end of PPDU indication sent in a cross link.

FIG. 10 illustrates an example scenario where the AP MLD 1014 and the non-AP MLD 1016 are operating under simultaneous transmit and receive (STR). In the STR example of FIG. 10, AP-1 of AP MLD 1014 and STA-1 of non-AP MLD 1016 are in communication using link 1 on 2.4 GHz with BW=20 MHz; and AP-2 of AP MLD 1014 and STA-2 of non-AP MLD 1016 are in communication using link 2 on 5 GHz with BW=80 MHz.

In FIG. 10, AP-1 is transmitting a PPDU 1002 on link 1 to STA-1. AP-2 is transmitting LP PPDU 1004 to STA-2 on link 2. During the PPDU transmission, AP-1 determines that the AP MLD 1014 has an HP PPDU for transmission to the non-AP MLD 1016 on link 2. The AP MLD 1014, therefore, sends a PPDU preemption request to the non-AP MLD 1016.

The preemption request can indicate a request for preempting the LP PPDUs 1004 being received on link 2 from STA-2. For the PPDU preemption, when the AP MLD 1014 receives HP packets and there is ongoing LP PPDU reception over link-2, AP-1 sends the A-Control subfield over link-1 as an indicator to the non-AP MLD 1016 for the preemption of LP PPDU 1004 over link-2. The AP MLD 1014 can encode a preemption request in an A-Control subfield within an MPDU of a PPDU 1002 being transmitted on link 1. AP-1 can send the preemption request to the non-AP MLD 1016 (to STA-1) on link 1 within a PPDU transmission. AP-1 can then continue sending PPDU on link-1.

STA-2, after receiving the preemption indication, encodes a “new end of PPDU” indicator in an A-Control subfield of the last MPDU of the last PPDU, the “new end of PPDU” encoding indicating the new end of the PPDU and then STA-2 preempts the LP PPDU 1004. Within a short interframe spacing (SIFS), the STA-2 can expect a HP PPDU from AP-2 on link 2. For example, after the end of the preempted LP PPDU 1004, the AP MLD 1014 can aggregate a BA with the HP MPDUs 1006 and transmit the PPDU. STA-2 can also set the TOT (Take over TXOP) field in the A-Control (along with the new end of PPDU) to let the AP-2 know that STA-2 can take over the TXOP after receiving the current MPDU.

In this case, AP-2 is taking over the TXOP initiated by STA-2, so it should comply with the initial TXOP duration initiated by the STA-2. This allows for quick takeover of the TXOP by the STA with the HP packets to send, meaning the HP packets can be sent quickly.

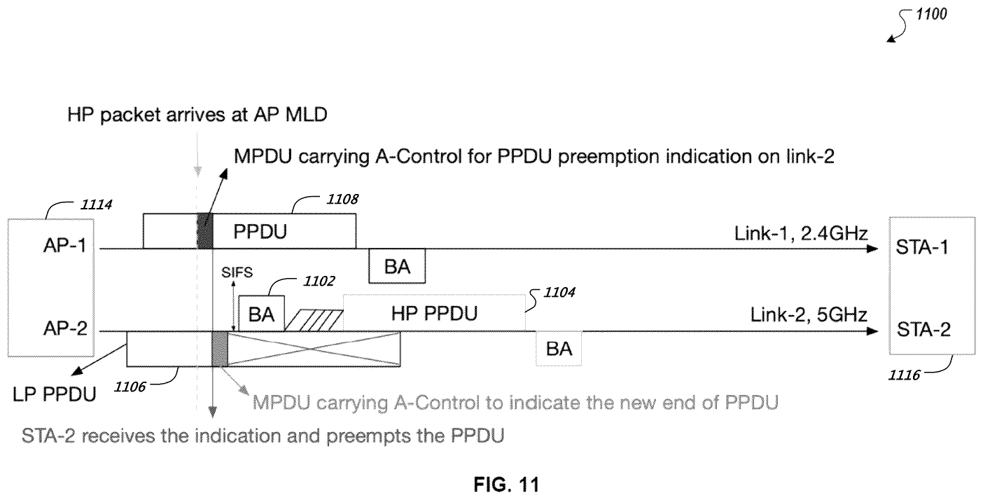

FIG. 11 is a schematic diagram of a second example MLO system 1100 that includes a PPDU preemption in accordance with some implementations of the present disclosure. Case 2 is similar to Case 1 (FIG. 10), but in FIG. 11, AP-2 needs a larger TXOP duration.

AP-2, after receiving the new end of PPDU, transmits the BA 1102 and initiates the channel access to start the HP PPDU transmission 1104. The channel access procedure can include the fact that AP-2 has HP traffic, and can also be configured to provide sufficient resources to transmit the HP packet (assuming the residual TXOP from STA-2 is insufficient to transmit the HP packet). In Case-2, AP-2 has a full TXOP to deliver the traffic.

The information exchanged between STAs (between an AP MLD and non-AP MLD in the case of FIGS. 10 and 11) may take some time. The exchange of preemption requests can delay the possible preemption event at STA-2. Notably, STA-2 can decide whether to perform the preemption.

STA-2, upon determining the preemption, sends the next MPDU with the A-Control containing the new end of PPDU indication, which indicates to the AP-2 that the preemption happens after MPDU with the new end of PPDU indicator. If the preemption indication (A-Control in MPDU sent from AP-1 to STA-1 on link 1) is not received by STA-1 of non-AP MLD 1116, then STA-2 continues the LP PPDU transmission 1106 on link 2.

Upon STA-2's decision for preemption, if the new end of PPDU indication (A-Control in MPDU sent by STA-2 on link 2) is not received by AP-2, AP-2 continues the reception of the LP PPDUs 1106 on link 2 up to L-SIG duration. So, the AP MLD 1114 would not send the BA 1102 with HP PPDU 1104 within the SIFS after the preempted PPDU 1108, but rather waits until the end of LP PPDU reception to start transmitting the HP PPDU 1104. Again, the transmission of the HP PPDU 1104 after the reception of full LP PPDU 1106 would follow channel contention procedures, which can delay transmission of the HP packet.

In some implementations, a STA can use the “new end of PPDU” indication for preempting its own PPDU and receiving a BA for the delivered MPDUs. Below are some examples for single-link and EMLSR scenario:

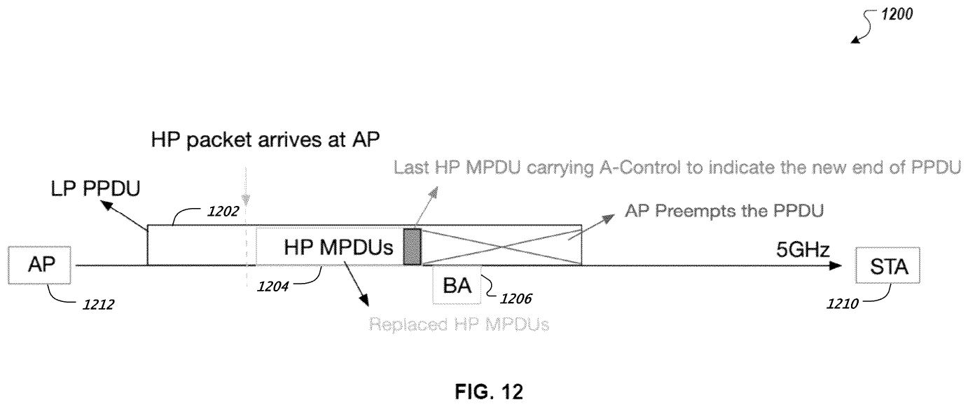

FIG. 12 is a schematic diagram illustrating a single-link system 1200 where a STA 1210 preempts its own PPDU 1202 in accordance with some implementations of the present disclosure. The AP 1212 transmitting LP PPDUs 1202 determines that it has HP traffic for DL transmission to the STA 1210. The AP 1212 replaces the LP MPDUs with the HP MPDUs 1204 in the LP PPDU 1202. Since the AP 1212 wants to receive the BA 1206 right after the HP MPDUs 1204 transmission, it sends the new end of PPDU indication in the last HP MPDU and preempts the LP PPDU 1202 (preempting meaning that the AP1212 ceases transmission of the LL PPDUs 1202 after transmission of the HP MPDUs 1204). The STA 1210 upon receiving the new end of PPDU indication, transmits the BA 1206 for all the received MPDUs, including the HP MPDUs 1204.

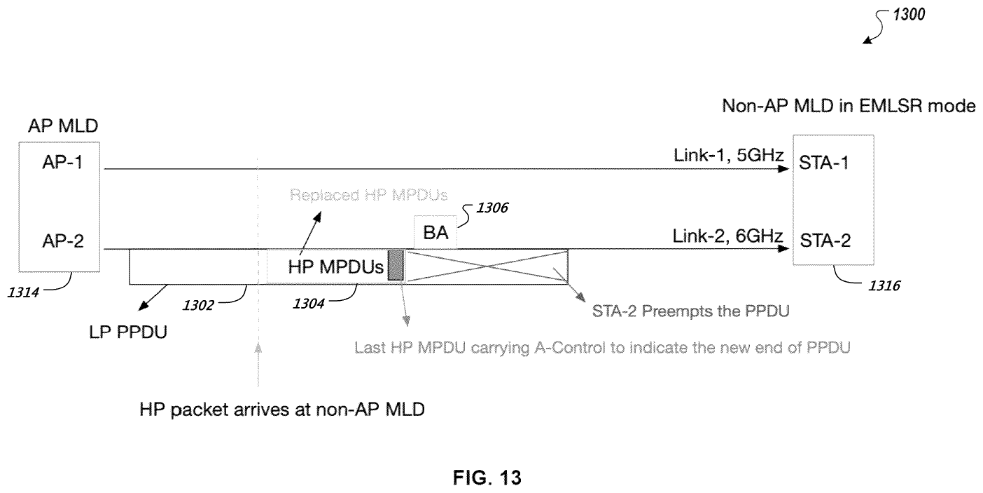

FIG. 13 is a schematic diagram illustrating an enhanced multi-link single radio (EMLSR) system 1300 where a STA preempts its own PPDU in accordance with some implementations of the present disclosure. In FIG. 13, the STA-2 is sending LP PPDUs 1302 on the uplink to AP-2 on link 2. The non-AP MLD 1316 determines that it has HP traffic for sending on the UL on link 2. Because non-AP MLD 1316 is in EMLSR mode, the non-AP MLD 1316 cannot transmit over link 1 at the same time as the LP PPDU transmissions 1302 on link 2. Therefore, the STA-2 replaces the LP MPDUs with the HP MPDUs 1304 in the LP PPDUs 1302 being transmitted on link 2. STA-2 encodes a “new end of PPDU” indication in an A-Control frame of the last HP MPDU 1304 sent to AP-2 on link 2. The AP-2 can send a BA 1306 right after all of the HP MPDUs 1304 transmissions are received (i.e., after it decodes the “new end of PPDU” indication). STA-2 thus preempts the LP PPDU 1302.

In both cases, if A-Control is not received, the receiver continues reception of the LP PPDUs 1302 until the end of LP PPDU duration, and will send the BA 1306 after that.

An AP MLD 1314 may have established links between multiple non-AP MLDs on which the AP MLD 1314 can transmit LP PPDUs 1302. An AP MLD 1314 with HP traffic to send to one or multiple non-AP MLDs 1316 on the DL MU can send the PPDU preemption indication to the one or multiple non-AP MLDs 1316 in DL (e.g., on the second link). Each non-AP MLD STA receiving the PPDU preemption indication can indicate, e.g., over the first link, the PPDU early termination for the SU or MU in UL if the non-AP MLD STA 1316 accepts the request.

The AP MLD 1314 can encode the preemption request into different MPDUs, each MPDUs directed to different non-AP MLDs 1316 in DL MU.

A non-AP MLD 1316 may have HP traffic to send to an AP MLD 1314. A non-AP MLD 1316 can send the PPDU preemption indication in UL MU (UL OFDMA). The APs of AP MLD 1314 over the cross link can indicate the PPDU early termination for the MU in DL or UL ODFMA if the AP MLD 1314 accepts the preemption request. Then, the non-AP MLD 1316 can use the preempted link to send the HP traffic. Each non-AP MLD 1316 can encode the preemption request its own MPDU directed to the AP MLD 1314 in UL MU.

FIG. 14 illustrates a block diagram of an electronic device 1400, according to some implementations. The electronic device 1400 can be a cellular telephone, a smartwatch, an access point, a wireless speaker, an Internet-of-Things (IoT) device, among other examples. The electronic device 1400 includes hardware resources 1402 that include one or more processors (or processor cores) 1410, one or more memory/storage devices 1420, and one or more communication resources 1430, each of which can be communicatively coupled via a bus 1440.

The one or more processors 1410 include one or more devices configured to perform computational operations. For example, the one or more processors 1410 can include one or more microprocessors, application-specific integrated circuits (ASICs), microcontrollers, graphics processing units (GPUs), programmable-logic devices, and/or one or more digital signal processors (DSPs). The processors 1410 can include, for example, a processor 1412 and a processor 1414. The processor(s) 1410 can be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 1420 can include main memory, disk storage, or any suitable combination thereof. The memory/storage devices 1420 can include, but are not limited to, any type of volatile or nonvolatile memory such as dynamic random-access memory (DRAM), static random-access memory (SRAM), erasable programmable read-only memory (EPROM), electrically erasable programmable read-only memory (EEPROM), Flash memory, solid-state storage, etc. In some implementations, the memory/storage devices 1420 are coupled to one or more high-capacity mass-storage devices (not shown). In some examples, memory/storage devices 1420 can be coupled to a magnetic or optical drive, a solid-state drive, or another type of mass-storage device. In these examples, the memory/storage devices 1420 can be used by electronic device 1400 as fast-access storage for often-used data, while the mass-storage device is used to store less frequently used data.

The communication resources 1430 can include interconnection or network interface components or other suitable devices to communicate with one or more peripheral devices 1404 or one or more databases 1406 via a network 1408. For example, the communication resources 1430 can include wired communication components (e.g., for coupling via USB), cellular communication components, NFC components, Bluetooth® (or Bluetooth® Low Energy) components, Wi-Fi® components, and other communication components.

The communication resources 1430 include one or more devices configured to couple to and communicate on a wired and/or wireless network (i.e., to perform network operations), such as: control logic, one or more interface circuits and a set of antennas (or antenna elements) in an adaptive array that can be selectively turned on and/or off by control logic to create a variety of optional antenna patterns or “beam patterns.” Alternatively, instead of the set of antennas, in some examples, electronic device 1400 includes one or more nodes, e.g., a pad or a connector, which can be coupled to the set of antennas. Thus, electronic device 1400 might or might not include the set of antennas. For example, communication resources 1430 can include a Bluetooth™ networking system, a cellular networking system (e.g., a 3G/4G/5G/6G network such as UMTS, LTE, etc.), a universal serial bus (USB) networking system, a networking system based on the standards described in IEEE 802.11 (e.g., a Wi-Fi® networking system), an Ethernet networking system, and/or another networking system.

In some implementations, communication resources 1430 includes one or more radios, such as a wake-up radio that is used to receive wake-up frames and wake-up beacons, and a main radio that is used to transmit and/or receive frames or packets during a normal operation mode. The wake-up radio and the main radio can be implemented separately (such as using discrete components or separate integrated circuits) or in a common integrated circuit.

The communication resources 1430 include processors, controllers, radios/antennas, sockets/plugs, and/or other devices used for coupling to, communicating on, and handling data and events for each supported networking system. Note that mechanisms used for coupling to, communicating on, and handling data and events on the network for a network system are sometimes collectively referred to as a “network interface” for the network system.

Instructions 1450 can include software, a program, an application, an applet, an app, or other executable code for causing at least any of the processors 1410 to perform any one or more of the methodologies discussed herein. The instructions 1450 can reside, completely or partially, within at least one of the processors 1410 (e.g., within the processor's cache memory), the memory/storage devices 1420, or any suitable combination thereof. In some implementations, any portion of the instructions 1450 can be transferred to the hardware resources 1402 from any combination of the peripheral devices 1404 or the databases 1406. Accordingly, the memory of processors 1410, the memory/storage devices 1420, the peripheral devices 1404, and the databases 1406 are examples of computer-readable and machine-readable media.

While the preceding discussion used a Wi-Fi communication protocol as an illustrative example, in other implementations a wide variety of communication protocols and, more generally, wireless communication techniques can be used. Thus, the communication techniques can be used in a variety of network interfaces. Furthermore, while some of the operations in the preceding implementations were implemented in hardware or software, in general the operations in the preceding implementations can be implemented in a wide variety of configurations and architectures. Therefore, some or all of the operations in the preceding implementations can be performed in hardware, in software or a combination of both. For example, at least some of the operations in the communication techniques can be implemented using instructions 1450, operating system (such as a driver for an interface circuit in communication resources 1430) or in firmware in an interface circuit in communication resources 1430. Additionally or alternatively, at least some of the operations in the communication techniques can be implemented in a physical layer, such as hardware in an interface circuit in communication resources 1430. In some implementations, the communication techniques are implemented, at least in part, in a MAC layer and/or in a physical layer in an interface circuit in communication resources 1430.

While the preceding implementations illustrated the use of wireless signals in one or more bands of frequencies, in some implementations, electromagnetic signals in one or more different frequency bands are used to determine the range. For example, these signals can be communicated in one or more bands of frequencies, including: a microwave frequency band, a radar frequency band, 900 MHZ, 2.4 GHz, 5 GHZ, 6 GHz, 60 GHz, and/or a band of frequencies used by a Citizens Broadband Radio Service, by LTE, 5G, or any other communication system.

Although specific components are used to describe electronic device 1400, in some implementations, different components and/or subsystems can be present in electronic device 1400. For example, electronic device 1400 can include one or more additional processing subsystems, memory subsystems, networking subsystems, and/or display subsystems. Additionally, one or more of the subsystems might not be present in electronic device 1400. In some implementations, electronic device 1400 can include one or more additional subsystems that are not shown in FIG. 14. In some implementations, electronic device can include an analysis subsystem that performs at least some of the operations in the communication techniques. Although separate subsystems are shown in FIG. 14, in some implementations some or all of a given subsystem or component can be integrated into one or more of the other subsystems or component(s) in electronic device 1400.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

In the following sections, further exemplary embodiments are provided.

Example 1 is method performed by a first wireless device for transmitting a high priority (HP) packet, the method comprising identifying an HP packet for uplink transmission; determining that a communications link for transmitting the HP packet is busy; generating a preemption request message; associating the preemption request message with a frame; and transmitting the frame to a second wireless device.

Example 2 may include the subject matter of example 1, wherein associating the preemption request message with the frame comprises encoding the preemption request message in an A-Control subfield of a QoS-Null frame, a QoS Data frame, or a management frame.

Example 3 may include the subject matter of example 2, wherein the QoS-Null frame, the QoS Data frame, or the management frame is encoded in a MAC protocol data unit (MPDU).

Example 4 may include the subject matter of example 1, wherein generating a preemption request message comprises encoding the preemption request message in the preamble of a PPDU comprising a Control Response frame.

Example 5 may include the subject matter of any of examples 1-4, wherein the communications link is busy due to the second wireless device performing a frame burst; and the method further comprising: receiving, from the second wireless device, a trigger frame comprising a resource allocation for sending the HP packet; and sending the HP packet to the second wireless in accordance with the resource allocation indicated by the trigger frame.

Example 6 may include the subject matter of any of examples 1-4, wherein the communications link is busy due to the second wireless device being engaged in an on-going transmission opportunity (TXOP).

Example 7 may include the subject matter of example 5, further comprising receiving, from the second wireless device, a contention free (CF) end message; contending for channel access; and transmitting the HP packet using resources allocated after contending for channel access.

Example 8 may include the subject matter of any of examples 6-7, further comprising receiving an MU PPDU; identifying an element of HP data to send; encoding a preemption request message in a multi-STA BA; and sending the multi-STA BA to the second wireless device.

Example 9 may include the subject matter of example 8, further comprising receiving a trigger frame for sending the HP data; and sending the HP data using a resource associated with the trigger frame.

Example 10 may include the subject matter of example 8, further comprising receiving an RDG message; and sending the HP data in accordance with an RDG parameter associated with the RDG message.

Example 11 may include the subject matter of example 8, further comprising receiving an indication of a contention free end period; contending for channel access to a channel; and transmitting the HP data on the channel.

Example 12 may include the subject matter of any of examples 1-4, wherein the communications link is busy due to the second wireless device transmitting one or more physical protocol data units (PPDU).

Example 13 may include the subject matter of example 12, further comprising receiving an MU PPDU that comprises a preemption request message; and encoding a new end of PPDU indication in an MPDU associated with an MU PPDU or an SU PPDU.

Example 14 may include the subject matter of example 12, further comprising receiving a second element of HP data from the second wireless device.

Example 15 may include the subject matter of any of examples 13 or 14, further comprising receiving a multi-STA BA during a SIFS period prior to receiving the second element of HP data.

Example 16 may include the subject matter of any of examples 1-5, wherein determining that the communications link for transmitting the HP packet is busy comprises determining that a first link of a multi-link connection is busy.

Example 17 may include the subject matter of example 16, wherein transmitting the frame to the second wireless device comprises transmitting the frame on a second link of the multi-link connection, wherein the preemption request identifies the first link for transmitting the HP packet.

Example 18 may include the subject matter of example 16, wherein transmitting the frame comprises transmitting the frame on the first link of the multi-link connections, the preemption request identifying the first link for transmitting the HP packet.

Example 19 is a method performed by a first wireless device in communication with a second wireless device over a wireless link, the method comprising sending one or more lower priority PPDUs to the second wireless device; receiving, from the second wireless device, a request for preemption of a current communication, wherein the request for preemption is received in a QoS-Null frame associated with a Control Response frame, a QoS Data frame, or a management frame; determining to preempt the current communication; sending at least one of a preemption indication or an end of PPDU indication to the second wireless device; and receiving a high priority packet from the second wireless device on the wireless link.

Example 20 may include the subject matter of example 19, wherein the preemption indication comprises an early block acknowledgement (BA) for a low priority MPDU, a trigger frame, a contention free end frame, or an RDG indication, allowing the second wireless device to use the wireless medium for sending the high priority packet.

Example 21 may include the subject matter of any of examples 19-20, wherein the request for preemption is encoded in an A-Control subfield of a Control Response frame, a QoS Data frame, or a management frame.

Example 22 may include the subject matter of any of examples 19-21, wherein the request for preemption comprises information corresponding to the high priority packet, including an indication of an amount of data associated with the high priority packet.

Example 23 may include the subject matter of example 19, further comprising encoding a new end of PPDU indication in a last MPDU of a low priority PPDU; transmitting the last MPDU in the last low priority PPDU to the second wireless device; and receiving an early BA.

Example 24 may include the subject matter of example 23, further comprising encoding a TXOP take over (TOT) indicator with the new end of PPDU indication to alert the second wireless device that the first wireless device will take over the TXOP.

Example 25 may include the subject matter of example 23, wherein the new end of PPDU indication is encoded in an A-Control subfield of a last MPDU associated with a TXOP.

Example 26 may include the subject matter of any of examples 27-25, further comprising sending a multi-user (MU) PPDU addressed to multiple second wireless devices; receiving, from at least one of the multiple second wireless devices, a multi-STA BA comprising the preemption request message; sending a contention free end indication or a trigger frame or using a reverse direction grant (RDG) mechanism to at least one of the multiple second wireless devices, wherein the RDG mechanism can grant the remaining TXOP to the second wireless device; and receiving, from at least one of the second multiple devices, the HP transmission.

Example 27 may include the subject matter of any of examples 19-23, further comprising encoding, in one or more MPDUs contained in a multi-user (MU) PPDU (MU PPDU), a preemption request message; sending the MU PPDU addressed to multiple second wireless devices; receiving, from at least one of the multiple second wireless devices, a new end of PPDU indication; transmitting an MU block acknowledgement to the at least one of the multiple second wireless devices; and transmitting the HP PPDU(s) to the at least one of the multiple second wireless devices.

Example 28 may include the subject matter of any of examples 19-27, wherein the first wireless device sends a preemption request indication to multiple second wireless devices operating in a multi-user network environment using a first link.

Example 29 may include the subject matter of example 28, wherein at least one of the multiple second wireless devices comprises a wireless station in a multi-link device (MLD).

Example 30 may include the subject matter of any of examples 29-30, further comprising, receiving from at least one of the multiple second wireless devices, a PPDU early termination indication that indicates that at least one second wireless device has accepted the preemption indication request.

Example 31 is an apparatus configured to perform any of the operations of examples 19-30.

Example 32 is an apparatus configured to perform any of the operations of examples 1-18.

Example 33 is an apparatus configured to perform the operations described in this specification.

Example 34 is an access point configured to perform any of the operations of claims 13-20.

Example 35 is an non-AP STA configured to perform the operations described in this specification.

Example 36 may include one or more non-transitory computer-readable media including instructions to cause an electronic device, upon execution of the instructions by one or more processors of the electronic device, to perform one or more elements of a method described in or related to any of examples 1-35, or any other method or process described herein.

Example 37 may include an apparatus including logic, modules, or circuitry to perform one or more elements of a method described in or related to any of examples 1-36, or any other method or process described herein.

Example 38 may include a method, technique, or process as described in or related to any of examples 1-37, or portions or parts thereof.

Example 39 may include an apparatus including: one or more processors and one or more computer-readable media including instructions that, when executed by the one or more processors, cause the one or more processors to perform the method, techniques, or process as described in or related to any of examples 1-38, or portions thereof.

Example 40 may include a signal as described in or related to any of examples 1-39, or portions or parts thereof.

Example 41 may include a datagram, information element, packet, frame, segment, PDU, or message as described in or related to any of examples 1-40, or portions or parts thereof, or otherwise described in the present disclosure.

Example 42 may include a signal encoded with data as described in or related to any of examples 1-41, or portions or parts thereof, or otherwise described in the present disclosure.

Example 43 may include a signal encoded with a datagram, IE, packet, frame, segment, PDU, or message as described in or related to any of examples 1-42, or portions or parts thereof, or otherwise described in the present disclosure.

Example 44 may include an electromagnetic signal carrying computer-readable instructions, wherein execution of the computer-readable instructions by one or more processors is to cause the one or more processors to perform the method, techniques, or process as described in or related to any of examples 1-43, or portions thereof.

Example 45 may include a computer program including instructions, wherein execution of the program by a processing element is to cause the processing element to carry out the method, techniques, or process as described in or related to any of examples 1-44, or portions thereof. The operations or actions performed by the instructions executed by the processing element can include the methods of any one of examples 1-30.

Example 47 may include a method of communicating in a wireless network as shown and described herein.

Example 48 may include a system for providing wireless communication as shown and described herein. The operations or actions performed by the system can include the methods of any one of examples 1-47.

Example 49 may include a device for providing wireless communication as shown and described herein. The operations or actions performed by the device can include the methods of any one of examples 1-48.

The previously described examples 1-49 are implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

A system, e.g., a base station, an apparatus including one or more baseband processors, and so forth, can be configured to perform particular operations or actions by virtue of having software, firmware, hardware, or a combination of them installed on the system that in operation causes or cause the system to perform the actions. The operations or actions performed either by the system can include the methods of any one of examples 1-20.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

What is claimed is:

1. A method performed by a first wireless device for transmitting a high priority (HP) packet, the method comprising:
identifying the HP packet for uplink transmission;
determining that a communications link for transmitting the HP packet is busy;
generating a preemption request message;
associating the preemption request message with a frame; and
transmitting the frame to a second wireless device.

2. The method of claim 1, wherein associating the preemption request message with the frame comprises encoding the preemption request message in an A-Control subfield of a QoS-Null frame, a QoS Data frame, or a management frame.

3. The method of claim 2, wherein the QoS-Null frame, the QoS Data frame, or the management frame is encoded in a MAC protocol data unit (MPDU).

4. The method of claim 1, wherein generating the preemption request message comprises encoding the preemption request message in a preamble of a PPDU comprising a Control Response frame.

5. The method of claim 1, wherein the communications link is busy due to the second wireless device being engaged in an on-going transmission opportunity (TXOP).

6. The method of claim 1, wherein the communications link is busy due to the second wireless device performing a frame burst, the method further comprising:
receiving, from the second wireless device, a trigger frame comprising a resource allocation for sending the HP packet; and
sending the HP packet to the second wireless device in accordance with the resource allocation indicated by the trigger frame.

7. The method of claim 6, further comprising:
receiving, from the second wireless device, a contention free (CF) end message;
contending for channel access; and
transmitting the HP packet using resources allocated after contending for channel access.

8. The method of claim 6, further comprising:
receiving an MU PPDU;
identifying an element of HP data to send;
encoding the preemption request message in a multi-STA BA; and
sending the multi-STA BA to the second wireless device.

9. The method of claim 8, further comprising:
receiving the trigger frame for sending the HP data; and
sending the HP data using a resource associated with the trigger frame.

10. The method of claim 8, further comprising:
receiving an RDG message; and
sending the HP data in accordance with an RDG parameter associated with the RDG message.

11. The method of claim 8, further comprising:
receiving an indication of a contention free end period;
contending for channel access to a channel; and
transmitting the HP data on the channel.

12. The method of claim 1, wherein the communications link is busy due to the second wireless device transmitting one or more physical protocol data units (PPDU).

13. The method of claim 12, further comprising:
receiving an MU PPDU that comprises the preemption request message; and
encoding a new end of PPDU indication in an MPDU associated with the MU PPDU or an SU PPDU.

14. The method of claim 12, further comprising receiving a second element of HP data from the second wireless device.

15. The method of claim 14, further comprising receiving a multi-STA BA during a SIFS period prior to receiving the second element of HP data.

16. The method of claim 1, wherein determining that the communications link for transmitting the HP packet is busy comprises determining that a first link of a multi-link connection is busy.

17. The method of claim 16, wherein transmitting the frame to the second wireless device comprises transmitting the frame on a second link of the multi-link connection, wherein the preemption request message identifies the first link for transmitting the HP packet.

18. The method of claim 16, wherein transmitting the frame comprises transmitting the frame on the first link of the multi-link connection, the preemption request message identifying the first link for transmitting the HP packet.

19. A method performed by a first wireless device in communication with a second wireless device over a wireless link, the method comprising:
sending one or more lower priority PPDUs to the second wireless device;
receiving, from the second wireless device, a request for preemption of a current communication;
determining to preempt the current communication;
sending at least one of a preemption indication or an end of PPDU indication to the second wireless device; and
receiving a high priority packet from the second wireless device on the wireless link.

20. An apparatus comprising:
one or more processors; and
memory storing instructions that, when executed, are configured to cause the one or more processors to perform operations comprising:
identifying a high priority (HP) packet for uplink transmission;
determining that a communications link for transmitting the HP packet is busy;
generating a preemption request message;
associating the preemption request message with a frame; and
transmitting the frame to a second wireless device.
